(19) United States
(12) Patent Application Publication
(10) Pub. No.: US 2007/0113248 A1
(43) Pub. Date: May 17, 2007

(54) Apparatus and method for determining genre of multimedia data

(75) Inventors: Doo Sun Hwang, Seoul (KR); Ji Yeun Kim, Seoul (KR); Young Su Moon, Seoul (KR); Jung Bae Kim, Yongin-si (KR); Eui Hyeon Hwang, Goyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/484,561

(22) Filed: Jul. 12, 2006

(30) Foreign Application Priority Data
Nov. 14, 2005 (KR) 10-2005-0108742

(51) Int. Cl. H04N 5/445; G06F 3/00; G06F 13/00

(52) U.S. Cl. 725/45

(57) ABSTRACT

The invention relates to a method and apparatus for determining a genre of multimedia data by analyzing the multimedia data, the apparatus including: a feature extractor extracting predetermined feature information from multimedia data; and a genre determination unit analyzing the extracted feature information of the multimedia data according to multimedia data genre determining logic associated with the extracted feature information and determining a genre of the multimedia data.

### CROSS-REFERENCE TO RELATED APPLICATION

This application claims the benefit of Korean Patent Application No. 10-2005-108742, filed on Nov. 14, 2005, in the Korean Intellectual Property Office, the disclosure of which is incorporated herein by reference.

### BACKGROUND OF THE INVENTION

1. Field of the Invention

The present invention relates to a method and apparatus for processing multimedia data, and more particularly, to a method and apparatus for determining a genre of multimedia data by analyzing the multimedia data.

2. Description of Related Art

As data compression technology and data transmission technology are developed, an increasing number of multimedia data is generated or transmitted on the Internet. It is difficult to search multimedia data desired by users from the large number of the multimedia data capable of being accessed on the Internet. Also, many users want only important information to be shown to them in a short time via a summary data that is a result of summarizing multimedia data. In response to the requirement of users, various methods of generating a summary of multimedia data are shown. Among the methods of generating the summary of multimedia data, there are methods of generating the summary according to a summary generation method suitable for a genre of the multimedia data. It is known that the method of selecting the summary generation method suitable for the genre generates more suitable summary than a method of generating a summary regardless of genre. However, in the conventional technologies, users have to determine a genre of multimedia data. Accordingly, the conventional technology may be applied to multimedia data whose genre is previously determined but may not be applied to multimedia data whose genre is not previously determined.

Therefore, there is required a method in which a genre of multimedia data is automatically determined and a summary generation method suitable for the determined genre is applied, thereby generating an optimal summary.

### BRIEF SUMMARY

An aspect of the present invention provides a multimedia data genre determination apparatus and method automatically determining a genre of multimedia data.

An aspect of the present invention also provides a multimedia data genre determination apparatus and method in which a genre of multimedia data is automatically determined, and an optimal summary of the multimedia data is generated by selecting a summary generation method suitable for the genre.

An aspect of the present invention also provides a multimedia data genre determination apparatus and method automatically identifying multimedia data included in an advertisement genre.

An aspect of the present invention also provides a multimedia data genre determination apparatus and method automatically identifying multimedia data included in a news genre.

An aspect of the present invention also provides a multimedia data genre determination apparatus and method automatically identifying multimedia data included in a drama/movie genre.

An aspect of the present invention also provides a multimedia data genre determination apparatus and method automatically identifying multimedia data included in a show/entertainment genre

An aspect of the present invention also provides a multimedia data genre determination apparatus and method automatically identifying multimedia data included in a sports genre.

According to an aspect of the present invention, there is provided a data genre determination apparatus including: a feature extractor extracting predetermined feature information from multimedia data; and a genre determination unit analyzing the extracted feature information of the multimedia data according to multimedia data genre determining logic associated with the extracted feature information and determining a genre of the multimedia data.

The genre determination unit may determine the genre of the multimedia data by using a shot change rate of a segment, which is a ratio of a number of total shots in the segment to a number of total frames in the segment.

The genre determination unit may determine the genre of the multimedia data by comparing predetermined face information for each genre and information obtained from a face image included in the multimedia data. The information obtained from the face image included in the multimedia data may be information on an area that is determined to be a face image in a frame selected from frames forming the multimedia data.

The genre determination unit may determine whether audio data included in the multimedia data is music data by analyzing the audio data and may determine the genre of the multimedia data by using a ratio of the music data to all of the multimedia data.

The genre determination unit may determine whether audio data included in the multimedia data is handclap/cheer data by analyzing the audio data and may determine the genre of the multimedia data by using a ratio of the handclap/cheer data to all of the multimedia data.

The genre determination unit may determine the genre of the multimedia data by using an occupation rate of a predetermined color in the frames forming the multimedia data.

According to another aspect of the present invention, there is provided a method of determining a genre of multimedia data, including: extracting predetermined feature information from the multimedia data; and analyzing the extracted feature information of the multimedia data according to multimedia data genre determination logic associated with the extracted feature information and determining a genre of the multimedia data.

According to another aspect of the present invention, there is also provided a multimedia data summary apparatus including a feature extraction unit extracting predetermined feature information from multimedia data, a genre determination unit determining a genre of the multimedia data by analyzing the extracted feature information according to a multimedia data genre determination logic associated with the extracted feature information, and a summary generator generating a summary of the multimedia data by using a summary generation method selected according to the determined genre.

According to still another aspect of the present invention, there is provided a multimedia data summary generation method including: extracting predetermined feature information from multimedia data, and determining a genre of the multimedia data by analyzing the extracted feature information of the multimedia data according to a multimedia data genre determination logic associated with the feature information.

According to other aspects of the present invention, there are provided computer readable recording media in which programs for executing the aforementioned methods are recorded.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of a multimedia data genre determination apparatus and a summary generation apparatus for generating a summary according to a genre of multimedia data, according to the present invention;

FIG. 2 is a diagram illustrating a frame, a shot, and a segment in multimedia data;

FIG. 3 is a diagram illustrating key frames extracted from multimedia data and segments, according to an embodiment of the present invention;

FIG. 4 is a flowchart illustrating a method of determining a genre of multimedia data by using a shot change rate according to an embodiment of the present invention;

FIGS. 5a and 5b are diagrams illustrating histograms of two frames in which a scene is converted, according to an embodiment of the present invention;

FIG. 6, parts (a)-(f), is a diagram illustrating a method of combining a plurality of shots into a segment, according to an embodiment of the present invention;

FIG. 7 is a flowchart illustrating a method of generating per-genre face information according to an embodiment of the present invention;

FIG. 8 is a diagram illustrating the per-genre face information generated according to an embodiment of the present invention;

FIGS. 9a-9d are diagrams illustrating a distribution of a face shown in multimedia data for each genre such as news, drama, entertainment show, and sports;

FIG. 10 is a flowchart illustrating a method of determining a genre of multimedia data by using face information of a frame, according to an embodiment of the present invention;

FIG. 11 is a diagram illustrating an example of dividing an image of a frame in order to detecting face information from multimedia data by a visual event processor of the present invention;

FIG. 12 is a flowchart illustrating an order of a method of detecting a face from multimedia data according to an embodiment of the present invention;

FIG. 13, parts (a)-(c), is a diagram illustrating a method of determining a genre of multimedia data by using face information according to an embodiment of the present invention;

FIGS. 14a-14c are diagrams illustrating a ratio of music data included in multimedia data for each genre such as music, drama, and sports.

### DETAILED DESCRIPTION OF EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

In the following description of embodiments of the present invention, multimedia data includes data including video data and audio data, data including only video data without audio data, and data including only audio data without video data.

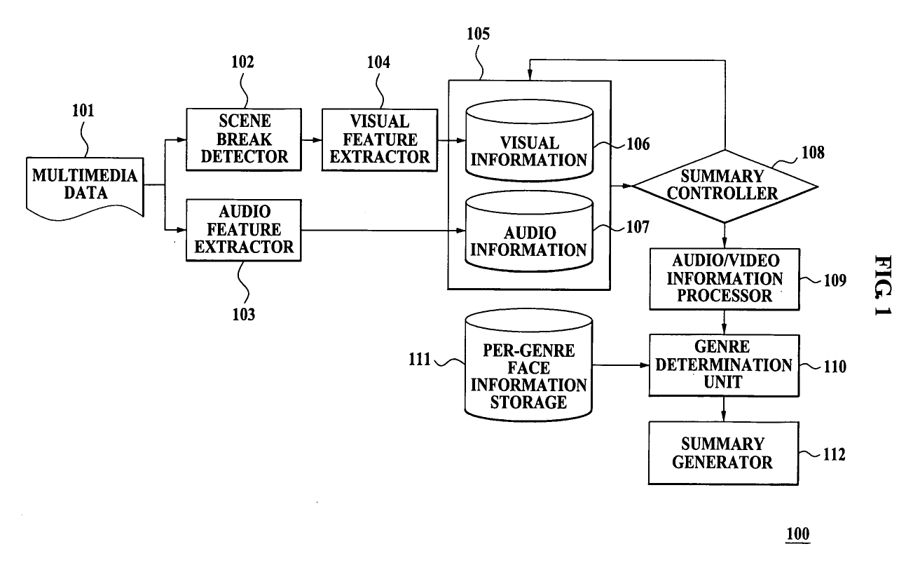

FIG. 1 is a block diagram of a multimedia data genre determination apparatus and a summary generation apparatus for generating a summary according to a genre of multimedia data, according to an embodiment of the present invention.

The summary generation apparatus includes a feature extractor and a genre determination unit. The feature extractor extracts predetermined feature information from the multimedia data. The genre determination unit determines the genre of the multimedia data by analyzing the feature information of the multimedia data according to a multimedia data genre determination logic associated with the feature information.

The feature extractor extracts features for determining a genre of multimedia data 101 from the multimedia data 101 and may include a visual feature extractor 104 and an audio feature extractor 103. The visual feature extractor 104 extracts visual features from the inputted multimedia data 101 and stores the visual features in a feature buffer 105. According to an embodiment of the present invention, visual information 106 stored in the feature buffer 105 by the visual feature extractor 104 includes time information and color information of key frames of a plurality of shots forming the multimedia data 101. The key frame is one or a plurality of frames selected from each shot and is a key of the shot. Accordingly, a frame capable of most properly reflecting a feature of the shot is selected as the key frame. According to an embodiment of the present invention, to quickly select the key frame, a first frame of the frames forming each shot is selected as the key frame. The time information is information on what order the key frame is in from an initial frame of the multimedia data 101. The color information is information on color forming the key frame and may be information on brightness of all pixels forming the key frame.

A multiplexer (not shown) extracts visual data and audio data from the inputted multimedia data 101, transmits the visual data to a scene break detector 102 and the visual feature extractor 104, and transmits the audio data to the audio feature extractor 103.

The scene break detector 102 detects a part of a scene break from the multimedia data 101 and outputs the part to the visual feature extractor 104. The scene break detector 102 is used when the visual feature extractor 104 must use information from multimedia data 101 which is divided into shots. Specifically, the scene break detector 102 is used in dividing the frames of the multimedia data into shots.

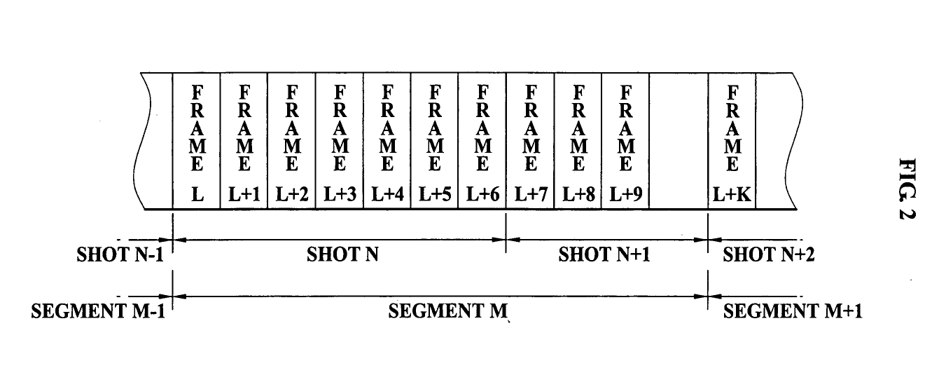

In video, a shot indicates a sequence of video frames acquired from one camera without interruption and is a unit for analyzing or forming the video. Also, in the video, there exists a segment, which is a meaningful component in developing a story or forming the video. Generally, there is a plurality of shots in one segment. The described concept of the shot and the segment may be identically applied to an audio program in addition to the video. A detailed construction of the scene break detector 102 will be described in detail later with reference to FIGS. 2 through 6.

The feature buffer 105 stores the visual feature information 106 and audio feature information 107 extracted by the visual feature extractor 104 and the audio feature extractor 103, respectively. The visual information 106 and the audio information 107 stored in the feature buffer 105 are used for determining the genre of the multimedia data 101.

A summary controller 108 monitors the feature buffer 105 and checks whether sufficient visual feature information or audio feature information is stored in the feature buffer 105. If the sufficient visual feature information or audio feature information is stored in the feature buffer 105, the summary controller 108 outputs the visual feature information or the audio feature information to an audio/video information processor 109 processes and outputs the visual feature information or the audio feature information stored in the feature buffer 105 to a genre determination unit 110. The audio/video information processor 109 may include a visual information processor processing visual feature information and an audio information processor processing audio feature information.

The genre determination unit 110 determines the genre of the multimedia data 101 by using values received from the audio/video information processor 109.

The summary generator 112 generates a summary of the multimedia data by using a summary generation method selected according to the determined genre. The summary generator 112 generates a summary of the multimedia data by using a summary generation method determined to be optimal for the genre of the multimedia data.

For example, when the genre of the multimedia data is news, a summary may be generated by using a method disclosed in U.S. Pat. No. 6,363,380, and when the genre of the multimedia data is sports such as soccer, a summary may be generated by using a method disclosed in U.S. Patent Publication No. 2004/0130567.

A method of determining a genre of multimedia data by using a shot change rate (SCR) within a segment, according to an embodiment of the present invention, will be described.

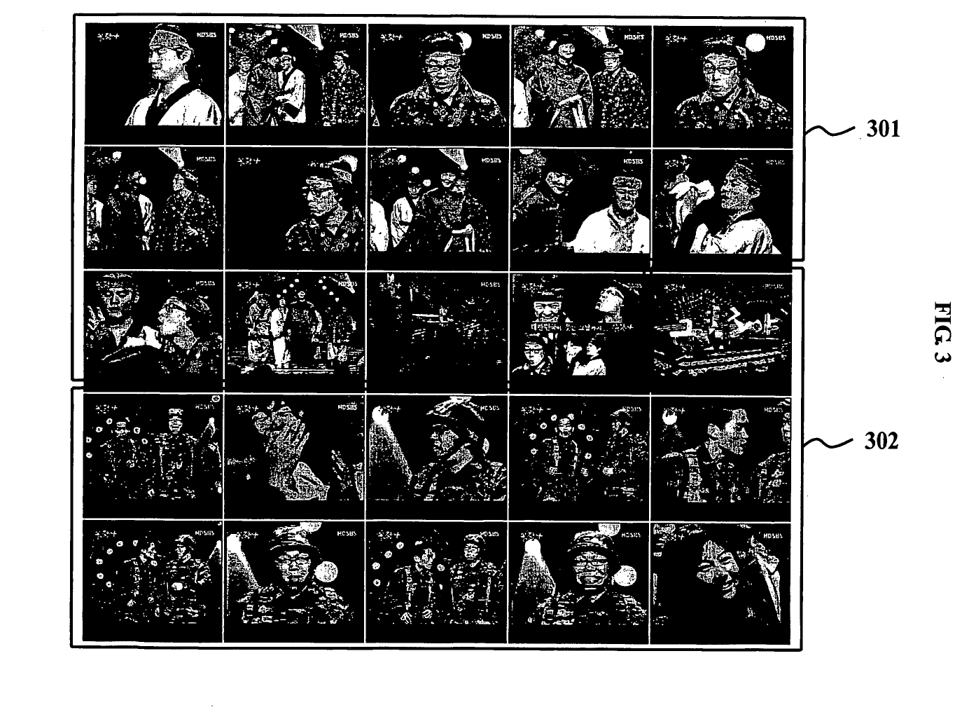

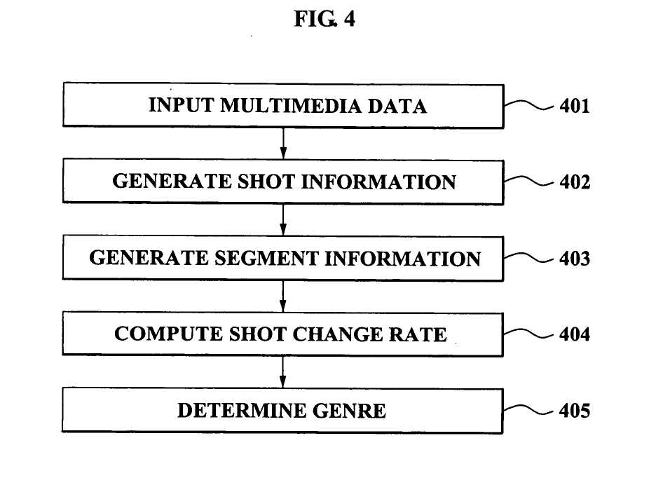

The SCR is a ratio of a number of total shots in a segment to a number of total frames in the segment. For easy understanding of the present embodiment, a shot and a segment will be described with reference to FIGS. 3 and 4.

In video, a shot indicates a sequence of video frames acquired from one camera without interruption. Also, in video, a segment is a meaningful component in developing a story or forming the video. Generally, there is a plurality of shots in one segment.

A frame, a shot, and a segment will be described with a situation in which a character A communicates with a character B in a restaurant, as an example. The face of the character A is photographed by a camera for 10 seconds in order to record video that the character A says. In this case, if the face of the character A is photographed by a ratio of 24 frames per minute, there are totally required 240 image frames. The face of the character B is photographed by the camera for five seconds in order to record video that the character B says. In this case, a total of 120 image frames are required. In this case, the 240 image frames of the face of the character A form a shot, and the 120 image frames of the face of the character B form another shot. Also, all shots that the character A and the character B communicate with each other in form one segment.

FIG. 2 is a diagram illustrating a frame, a shot, and a segment in multimedia data. In FIG. 2, frames from L to L+6 form a shot N, and frames from L+7 to L+K−1 form a shot N+1. Accordingly, a scene break occurs between the frame L+6 and the frame L+7. Also, the shot N and the shot N+1 form a segment M. Specifically, the segment is a set of at least one sequential shot, and the shot is a set of at least one sequential frame.

FIG. 3 is a diagram illustrating key frames extracted from multimedia data and segments, according to an embodiment of the present invention. Each image of FIG. 3 illustrates a key frame of the shot. As a result of combining the shots into the segments, fourteen shots 301 in the fore part form one segment and eleven shots 302 in the rear part form the other segment. FIG. 3 illustrates multimedia data of show/entertainments, in which the shots 301 form one episode and the shots 302 form the other episode, thereby dividing into different segments. Shots in an identical segment have high similarity to each other, and shots of different segments have relatively low similarity.

FIG. 4 is a flowchart illustrating a method of determining a genre of multimedia data by using a shot change rate according to an embodiment of the present invention. For ease of explanation only, this method is described with concurrent reference to FIG. 1.

In operation 401, the multimedia data is inputted.

In operation 402, shot information is generated by the scene break detector 102, which divides the multimedia data into a plurality of shots. In video, a shot indicates a sequence of video frames acquired from one camera without interruption.

The scene break detector 102 stores a previous frame image, computes similarity with respect to color histograms of two sequential frame images, Specifically, a present frame image and the previous frame image, and when the computed similarity is less than a certain threshold, computes the present frame as a frame in which a scene break occurs. In this case, similarity Sim(Hₜ, Hₜ₊₁) may be computed according to Equation 1.

$$Sim ( {H}_{t} , {H}_{t + 1} ) = {\sum }_{n = 1}^{N} min [ {H}_{t} ( n ) , {H}_{t + 1} ( n ) ] \qquad Equation 1$$

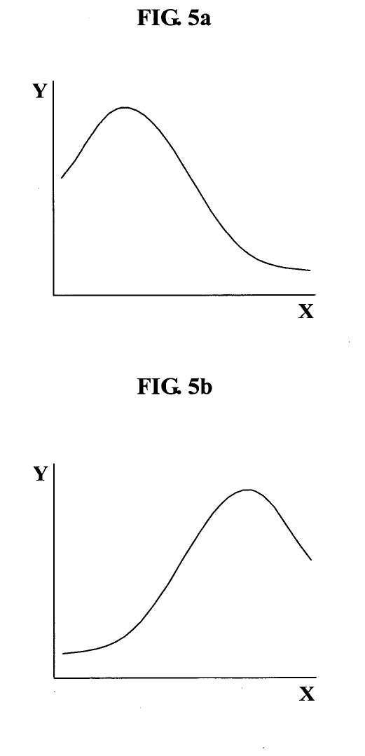

In this case, Hₜ indicates the color histogram of the previous frame image, Hₜ₊₁ indicates the color histogram of the present frame image, and N indicates a level of a histogram. A detailed description on the color histogram will be described later with reference to FIG. 5.

In addition to the described method, other methods of detecting, from visual information of multimedia data, the frame in which a scene break occurs may be used by the scene break detector 102. For example, other methods of detecting the frame in which the scene break occurs are disclosed in U.S. Pat. No. 5,767,922, U.S. Pat. No. 6,137,544, and U.S. Pat. No. 6,393,054.

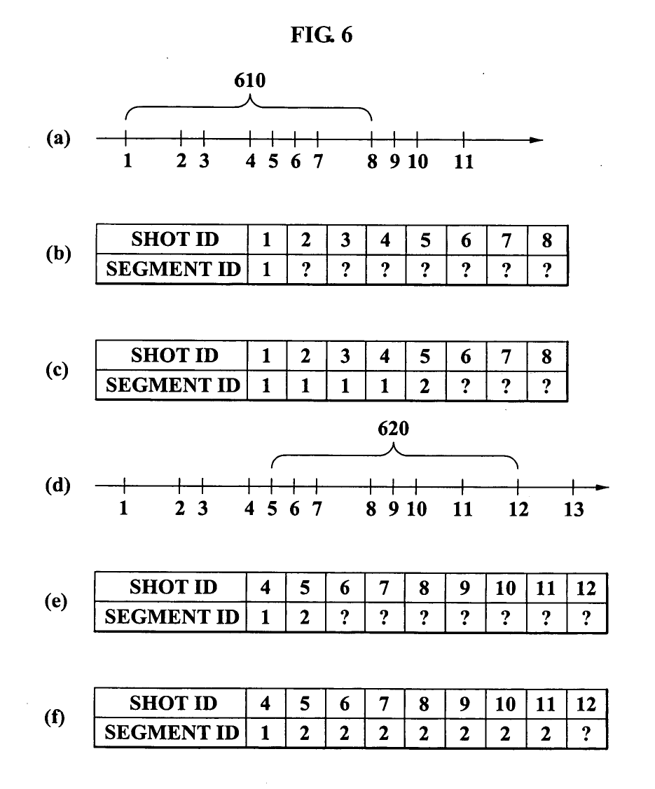

In operation 403, segment information is generated by the visual information processor 109, which combines the shots into at least one segment according to predetermined standards. Later, a method of determining one segment by combining at least one shot will be described in detail with reference to FIG. 6.

In operation 404, a shot change is computed by the visual information processor 109, which computes the SCR of a segment forming multimedia data. The SCR is a ratio of a number of total shots in a segment to a number of total frames in the segment. In this case, the SCR may be computed according to Equation 2.

$$SCR = \frac{S}{N} \qquad Equation 2$$

In this case, S is a number of shots included in a segment and N is a number of total frames included in the segment.

For example, since a number of the shots included in a segment M is two, the shot N and the shot N+1, and a number of total frames included in the segment M is K, the SCR of the segment becomes 2/K.

In operation 405, the genre determination unit 110 determines a genre of the multimedia data by using the SCR of the segment forming the multimedia data.

Since there are many shots for one segment in multimedia data of an advertisement genre, the SCR is high. Accordingly, when the SCR is more than a predetermined threshold, the genre of the multimedia data is determined to be advertisement.

In FIGS. 5a and 5b are graphs which illustrate histograms of two frames in which a scene break occurs, to easily understand the scene break detector 102 of the present embodiment.

In FIGS. 5a and 5b, a horizontal axis indicates a level of brightness and a vertical axis indicates frequency, respectively. There are more dark pixels than bright pixels in pixels forming the frame illustrated in FIG. 5a. There are more bright pixels than dark pixels in pixels forming the frame illustrated in FIG. 5b. In the case of a scene in which the character A communicates with the character B in the restaurant, when the scene that the character A gives his lines is formed of 240 sequential frames, distribution of a histogram is similar between the frames. However, if a scene break occurs, there is a great difference in the histogram between previous/subsequent frames, in which the scene break occurs. Accordingly, it may be determined via computing of similarity of Equation 1 whether the scene break occurs.

FIG. 6 is a diagram illustrating a method of combining a plurality of shots into a segment, according to an embodiment of the present invention.

According to an embodiment of the present invention, the visual information processor 109 combines shots into at least one segment by using similarity of a color pattern of each key frame of the shot. A first frame of a plurality of frames forming the shot may be used as the key frame of the shot. In this case, similarity of neighboring shots may be determined by using the similarity of the color pattern of the key frames of the neighboring shots. In determining the similarity of the color pattern, one of the described methods used in detecting the scene break may be used. In this case, a method different from a similarity determination method used in determining a shot may be applied to a similarity determination method used in determining a segment. For example, a method of using a histogram may be used in determining the shot, and the method disclosed in U.S. Pat. No. 6,724,933 may be used in determining the segment. Also, the same similarity determination method used in determining the segment may be used in determining the shot. In this case, a threshold may be different.

Each of parts (a) through (d) of FIG. 6 illustrates sequential shots in an order that time passes in the direction of an arrow. In FIG. 6, parts (b), (c), (e), and (f) are tables illustrating shot identifiers matched with segment identifiers. In the table, ‘?’ of the segment identifier indicates that the segment identifier is not yet determined.

To more easily understand the present embodiment, a size of a search window, specifically, a first predetermined number is assumed to be 8, however, the present embodiment is not limited by this non-limiting example.

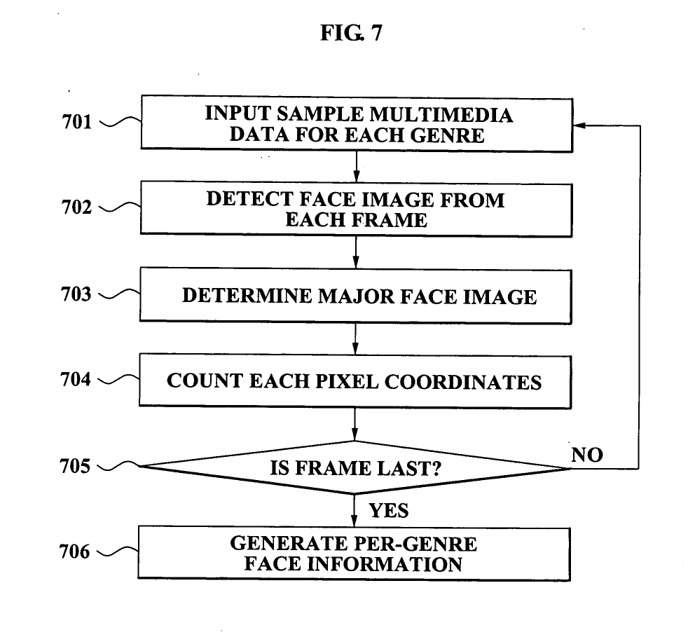

To combine shots 1 to 8 included in a search window 610 shown in (a) of FIG. 6, as shown in (b) of FIG. 6, a shot identifier of a first shot is established as a random number, for example, ‘1’ as shown in (b) of FIG. 7. In this case, the audio/video information processor 109 computes the similarity of two shots by using color information of the first shot whose shot ID is 1 and color information of a second shot whose shot ID is 2 to an eighth shot whose shot ID is 8.

For example, the audio/video information processor 109 may examine the similarity of two shots from the last shot. Specifically, the audio/video information processor 109 compares the color information of the first shot whose shot ID is 1 with the color information of the eighth shot whose shot ID is 8, and then compares the color information of the first shot whose shot ID is 1 with the color information of the seventh shot whose shot ID is 7. Next, the audio/video information processor 109 compares the color information of the first shot whose shot ID is 1 with the color information of the sixth shot whose shot ID is 6. Therefore, the similarity of the first shot whose shot ID is 1 with each of the shots from the second shot whose shot ID is 2 to the eighth shot whose shot ID is 8 is examined.

In this case, to determine a degree of the similarity, histogram similarity comparison of Equation 1 may be used.

The audio/video information detector 109 compares the similarity [Sim(H1 and H8)] between the first shot whose shot ID is 1 and the eighth shot whose shot ID is 8 with a critical value. When the similarity [Sim(H1 and H8)] between the first shot whose shot ID is 1 and the eighth shot whose shot ID is 8 is determined to be less than the critical value, the similarity [Sim(H1 and H7)] between the first shot whose shot ID is 1 and the seventh shot whose shot ID is 7 is compared with the critical value. In this case, when the similarity [Sim(H1 and H7)] between the first shot whose shot ID is 1 and the seventh shot whose shot ID is 7 is more than the critical value, a segment identifier from the first shot whose shot ID is 1 to the seventh shot whose shot ID is 7 is determined to be a predetermined value, for example, ‘1’. In this case, the similarity between the first shot whose shot ID is 1 and from the sixth shot whose shot ID is 6 to the second shot whose shot ID is 2 is not compared. As described above, segment information may be generated by using at least one shot comparison. The audio/video information processor 109 combines the first shot whose shot ID is 1 to the seventh shot whose shot ID is 7 into one segment whose segment ID is 1.

Hereinafter, a method of determining a genre of multimedia data by using face information of image data included in the multimedia data will be described. For this, a method of generating per-genre face information will be described with reference to FIGS. 7 through 9.

FIG. 7 is a flowchart illustrating a method of generating per-genre face information according to an embodiment of the present invention.

In operation 701, sample multimedia data for each genre is inputted. The sample multimedia data for each genre is multimedia data whose genre is previously determined. A user may determine a genre of several multimedia data, and the multimedia data may be used as sample multimedia data for each genre.

In operation 702, a face image of each of the frames selected from the sample multimedia data is detected. Specifically, with respect to the selected frames, what area is a face area is determined. When the sample multimedia data is divided into shots, the selected frames may be key frames of the shot. The face area may be determined by using appearance information of a face in an image of the key frame.

In operation 703, whether a part determined to be the face area is a major face image is determined. For example, when the face image determined to be the face area in the key frame is maintained for a certain time, for example, more than five seconds, the face area may be determined to be the major face image. According to another example of the present embodiment, when the detected face image occupies more than a certain part of the selected frame, for example, the key frame, the face area may be determined to be the major face image. According to still another example of the present embodiment, when the detected face image is located in a predetermined interesting area, the face area may be determined to be the major face image. Specifically, when a certain coordinate area is determined in the whole frame and the determined face area overlaps the coordinate area at more than a predetermined ratio, the face area may be determined to be the major face image. Also, the major face image may be determined by combining the two described methods and other methods. This is for quickly determining the genre by removing information that is not the major face image from the per-genre face information.

As described above, in operation 703, a face image that is not the major face image from the face images detected from the frames of the sample multimedia data selected for each genre is not included in pixels determined to be the face image, thereby inserting information with respect to the major face into the per-genre face information. Therefore, precision of determining the genre is improved.

In operation 704, each of the pixel coordinates included in the major face area, for each of the pixel coordinates of the frame are counted. In operation 705, whether the frame is a last frame is determined. If the frame is not the last frame, the operations from operation 701 are repeated. As described above, when processing the last frame of one sample multimedia data, for each pixel of the total scene, a number of times that the pixel is included in the major face area is determined.

In operation 706, face map information is generated by normalizing the number of times each pixel is included in the major face area. Per-genre face information associated with the face image for each genre, generated as described above, is stored in, for example, a per-genre face information storage.

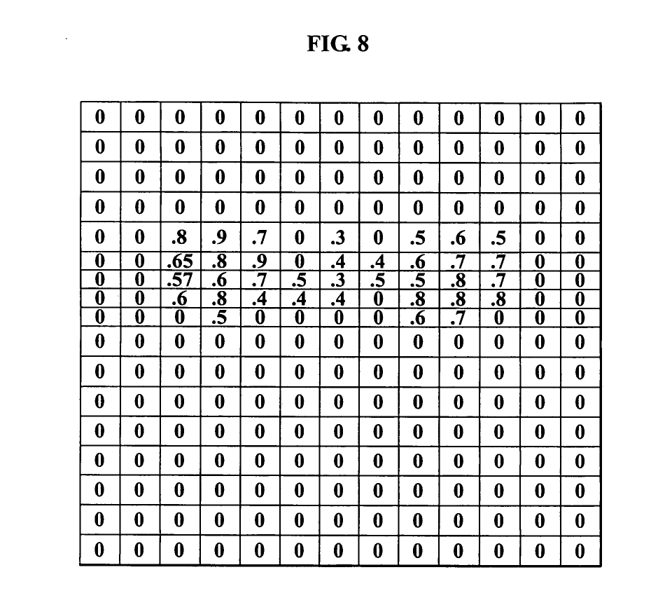

FIG. 8 is a diagram illustrating an example of the per-genre face information normalized as described. In FIG. 8, an image frame is formed of 13*17 pixels. When coordinates of a left top is (0, 0), a value of a pixel (3, 4) is 0.8 and a value of a pixel (4, 4) is 0.9. A reason of normalizing the number of times the pixel is included in the major face area is for comparing different genres to each other. Accordingly, each pixel has a value from 0 to 1. In this case, the standard of 1 may be a number of frames used in extracting the face information from the sample multimedia data for each genre, or a number of frames including at least one pixel included in the major face in the sample multimedia data for each genre. According to yet another embodiment of the present invention, the number of times that the pixel whose number of being included in the major face area of the sample multimedia data for each genre is included in the major face area is determined to be 1 and other pixels are normalized based on this.

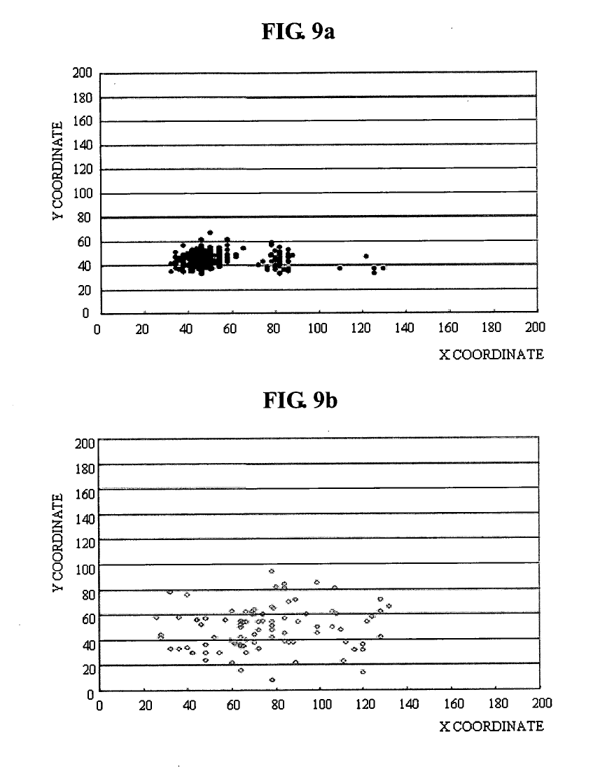

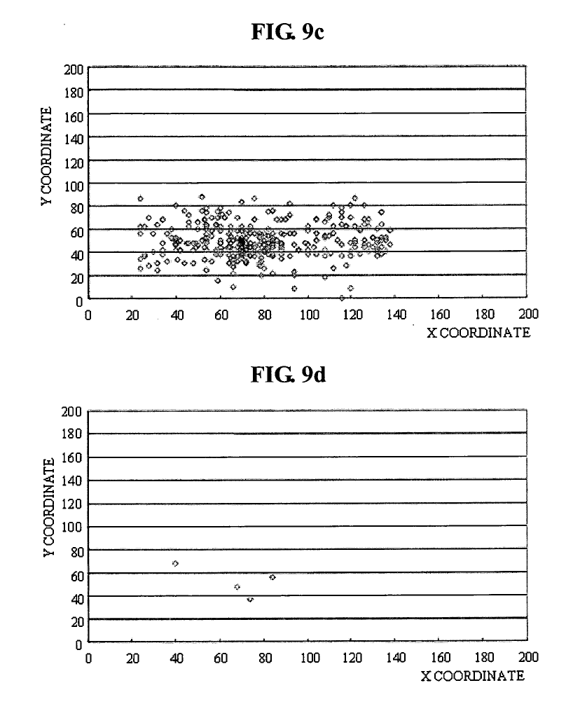

FIGS. 9a-9d are diagrams illustrating a distribution of a face shown in multimedia data for genres such as news (FIG. 9a), drama (FIG. 9b), entertainment (FIG. 9c), and sports (FIG. 9d).

FIGS. 9a-9d display density according to the number of times that the pixel is determined to be the major face area for each pixel. Referring to FIG. 9a, in the case of news, there are many face images between coordinates (40, 40) to coordinates (60, 60). Also, referring to FIG. 9d, in the case of sports, there exist relatively few pixels determined to be the major face area.

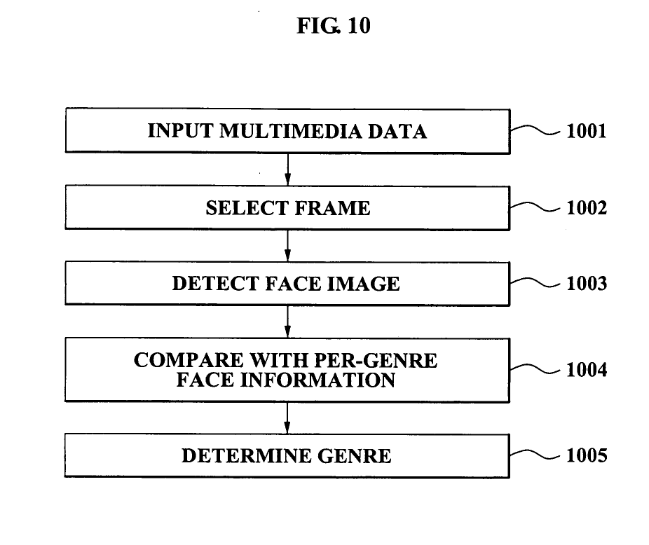

FIG. 10 is a flowchart illustrating a method of determining a genre of multimedia data by using face information of a frame, according to an embodiment of the present invention. For ease of explanation only, this method is described with concurrent reference to FIG. 1.

In operation 1001, multimedia data is inputted.

In operation 1002, the audio/video information processor 109 selects frames from the multimedia data. The selected frames may be key frames selected from frames forming a shot after dividing the multimedia data into a plurality of shots. A first frame of each shot may be used as the key frame.

In operation 1003, the audio/video information processor 109 detects information associated with a face image from the frames selected from the frames forming the multimedia data. Specifically, with respect to the selected frames, what area of pixels is a face area is determined. Determination of the face area may be performed by using appearance information of a face, appearance=texture+shape, from an image of the key frame. The visual information processor 109 may divide the image of the frame into a plurality of areas and may determine whether the divided areas include the face image. According to a further example of the present embodiment, an outline of the image of the frame may be extract and whether the area is the face image is determined according to color information of pixels in a plurality of closed curves generated by the described outline.

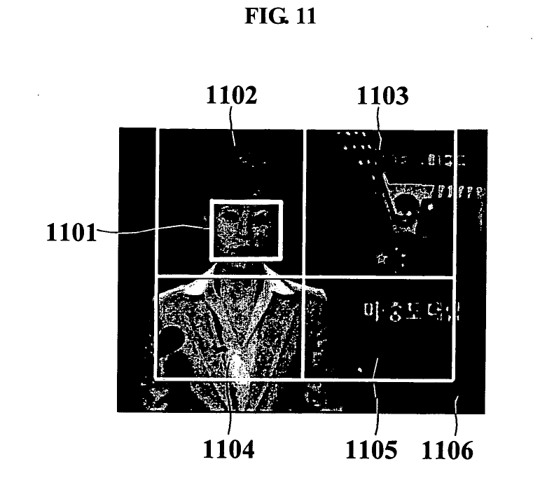

FIG. 11 is a diagram illustrating an example of dividing an image of a frame in order to detecting face information from multimedia data by a visual event processor of the present embodiment.

The audio/video information processor 109 of FIG. 1 detects a face from frames included in multimedia data. To detect the face, one frame image is divided into areas I through V 1102, 1103, 1104, 1105, and 1106, respectively.

In this case, a division position may be statistically obtained via an experiment or simulation. A division position shown in FIG. 11 is also obtained via an experiment. In dividing as described above, an area whose possibility of including a face area is high is determined. Generally, the area I 1102 is corresponding to an area whose possibility is highest. Accordingly, the audio/video information processor 109 of FIG. 1 tries to detect the face from the area I. The audio/video information processor 109 may determine whether the face is located in a relevant area according to a rate of pixels having a predetermined color value from pixels in the relevant area.

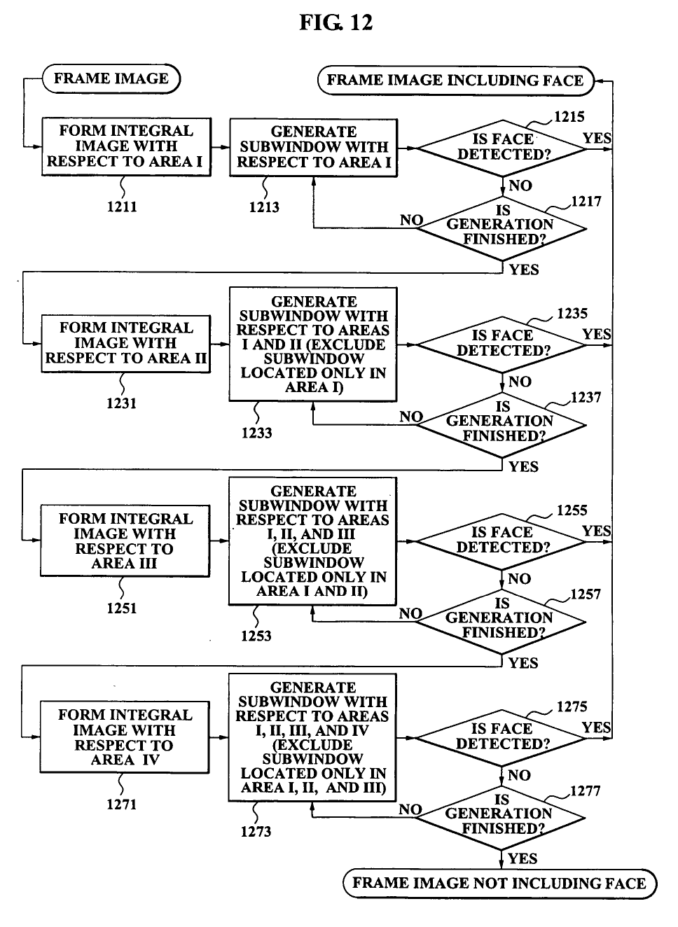

FIG. 12 is a flowchart illustrating an order of a method of detecting a face from multimedia data according to an embodiment of the present invention.

Referring to FIGS. 11 and 12, in operation 1211, an integral image with respect to the area I 1102 is formed. In operation 1213, a subwindow of the integral image with respect to the area I 1102 is generated. In operation 1215, whether a face is detected from the generated subwindow is determined, and a frame image including the face is formed by using the subwindow from which the face is detected. In operation 1217, when the face is not detected from the generated subwindow as a result of determination in operation 1215, whether the generation of the subwindow, with respect to the area I 1102, is finished is determined. When the generation of the subwindow with respect to the area I 1102 is not finished, the operations from operation 1213 are repeated, and when the generation of the subwindow with respect to the area I 1102 is finished, the operations from operation 1231 are performed.

In operation 1231, an integral image with respect to the area II 1103 is formed. In operation 1233, a subwindow of the integral images with respect to the area I 1102 and the area II 1103 is generated. In this case, the subwindow located only in the area I 1102 may be excluded. In operation 1235, whether a face is detected from the generated subwindow is determined, and a frame image including the face is formed by using the subwindow from which the face is detected. In operation 1237, when the face is not detected from the generated subwindow as a result of the determination of operation 1235, whether the generation of the subwindow with respect to the area I 1102 and the area II 1103 is finished is determined. When the subwindow with respect to the area I 1102 and the area II 1103 is not finished, the operations from operation 1233 are repeated, and when the subwindow with respect to the area I 1102 and the area II 1103 is finished, the operations from operation 1251 are performed.

In operation 1251, an integral image with respect to the area III 1104 is formed. In operation 1253, a subwindow of the integral images with respect to the area I 1102, the area II 1103, and the area III 1104 is generated. In this case, the subwindows located only in the area I 1102 and the area II 1103 may be excluded. In operation 1255, whether a face is detected from the generated subwindow is determined, and a frame image including the face is formed by using the subwindow from which the face is detected. In operation 1257, when the face is not detected from the generated subwindow as a result of the determination of operation 1255, whether the generation of the subwindow with respect to the area I 1102, the area II 1103, and the area III 1104 is finished is determined. When the subwindow with respect to the area I 1102, the area II 1103, and the area III 1104 is not finished, the operations from operation 1253 are repeated, and when the subwindow with respect to the area I 1102, the area II 1103, and the area III 1104 is finished, the operations from operation 1271 are performed.

In operation 1271, an integral image with respect to the area IV 1105 is formed. In operation 1273, a subwindow of the integral images with respect to the area I 1102, the area II 1103, the area III 1104, and the area IV 1105 is generated. In this case, the subwindows located only in the area I 1102, the area II 1103, and the area IV 1104 may be excluded. In operation 1275, whether a face is detected from the generated subwindow is determined, and a frame image including the face is formed by using the subwindow from which the face is detected. In operation 1277, when the face is not detected from the generated subwindow as a result of the determination of operation 1275, whether the generation of the subwindow with respect to the area I 1102, the area II 1103, the area III 1104, and the area IV 1105 is finished is determined. When the subwindow with respect to the area I 1102, the area II 1103, the area III 1104, and the area IV 1105 is not finished, the operations from operation 1273 are repeated, and when generation of the subwindow with respect to the area I 1102, the area II 1103, the area III 1104, and the area IV 1105 is finished, the relevant image is determined to be a frame image that does not include the face. The described operations can be performed by the audio/video information processor 109 of FIG. 1.

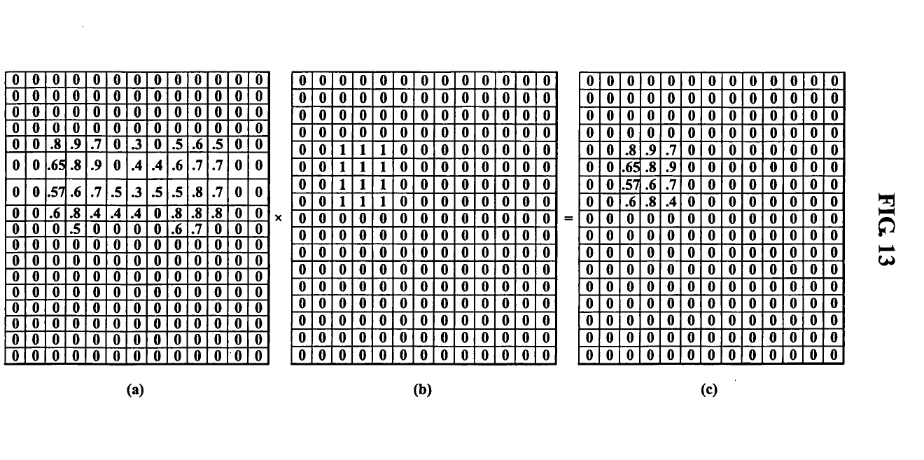

As described above, the visual information processor 109 of FIG. 1 determines what area is included in the face image from the frames selected from the frames forming the multimedia data. In FIG. 13, part (b) illustrates a part determined to be the face area from one frame by the visual information processor 109. Specifically, in part (b) of FIG. 13, a pixel whose value is 1 is the area determined to be the face image from the relevant frame.

Referring to FIG. 10, the operations from 1004 will be described.

In operation 1004, the genre determination unit 110 of FIG. 1 compares the information on the face image included in the multimedia data with the per-genre face information.

FIGS. 13a-13c are diagrams illustrating a method of determining a genre of multimedia data by using face information according to an embodiment of the present invention. FIG. 13a illustrates one per-genre face information. FIG. 13b illustrates information on the area determined to be the face image with respect to the frame selected from the multimedia data. FIG. 13c illustrates result values of multiplication for each corresponding pixel of FIG. 13a and FIG. 13b. In FIGS. 13a-13c, a genre determination coefficient is a value of adding the result values of each coordinates of FIG. 13c. The higher the genre determination coefficient, the higher the possibility that the genre of the multimedia data is the genre FIG. 13a. As described above, the multimedia data is compared with the per-genre face information stored in the per-genre face information storage 111 of FIG. 1.

In this case, the genre determination coefficient may be computed as Equation 3.

$$G = {\sum }_{K = 1}^{N} {( \frac{{\sum }_{j = 0}^{h - 1} {\sum }_{i = 0}^{w - 1} ( {I}_{ij} \times {T}_{ij} )}{FR} )}_{K} \qquad Equation 3$$

In this case, h is a vertical length of an image frame, which is a number of pixels forming a vertical axis of the image frame. In FIGS. 13a-13c, h is 17. In this case, w is a horizontal length of the image frame, which is a number of pixels forming a horizontal axis of the image frame. In FIGS. 13a-13c, w is 13. Iij indicates a value of each pixel after detecting the face area with respect to the frame extracted from the multimedia data that becomes an object whose genre is to be determined. Since FIG. 13b is the face area detected with respect to one frame of the multimedia data, Iij is a value corresponding to each pixel of FIG. 13b. For example, I (0, 0) is 0 and I (2, 4) is 1. Tij is a value of pixels in the per-genre face information. FIG. 13a illustrates the per-genre face information, Tij becomes a value of each pixel. N is a number of frames extracted from the multimedia data that is the object whose genre is to be determined, which is compared with the per-genre face information. When five frames are extracted from the multimedia data and compared with the per-genre face information, N is five. FR indicates a size that the face area occupies in the frame of the multimedia data. Referring to FIGS. 13a-13c, FR is 9. G is the genre determination coefficient.

Referring to FIG. 10, in operation 1005, the genre determination unit 110 of FIG. 1 determines the genre of the multimedia data by comparing the information on the face image included in the multimedia data with the per-genre face information. For example, the information on the face image included in the multimedia data is compared with the per-genre face information and a genre whose correlation is highest is determined to be the genre of the multimedia data.

According to this embodiment of the present invention, when the value of the genre determination coefficient computed by comparing the per-genre face information stored in the per-genre face information storage 111 with the multimedia data is more than a predetermined threshold, the multimedia data is determined to be the relevant genre. According to another example of the present embodiment, the per-genre face information having a highest genre determination coefficient with respect to the multimedia data is determined to be the genre of the multimedia data. In the case of news, as shown in FIGS. 9a-9d and 11, since the face area is shown in a certain position at high frequency, precision of detecting multimedia data of news genre may be improved by using the method.

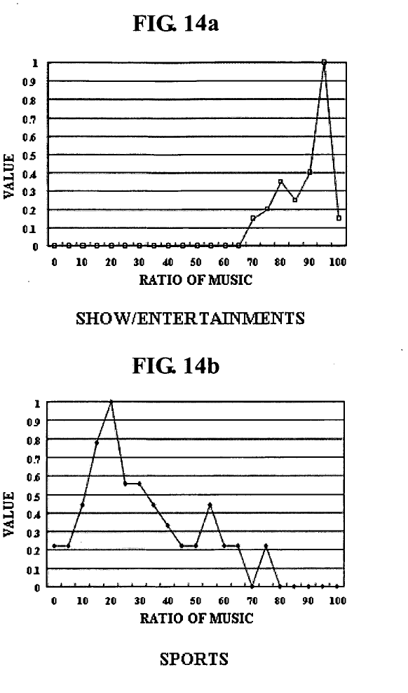

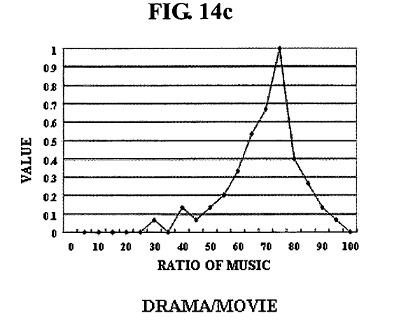

FIGS. 14a-14c are diagrams illustrating a ratio of music data included in multimedia data for each genre such as music (FIG. 14a), drama (FIG. 14b), and sports (FIG. 14c).

According to this embodiment of the present invention, the genre determination unit 110 determines whether audio data included in multimedia data is music data by analyzing the audio data, and determines a genre of the multimedia data by using a ratio of the music data included in the multimedia data. As shown in FIGS. 14a-14c, multimedia data of show/entertainment genre has a high ratio of music data that occupies the whole data. Accordingly, the multimedia data of the show/entertainment genre may be identified according to the ratio of music data that occupies the entire multimedia data.

The audio feature extractor 103 of FIG. 1 extracts audio features from auditory component inputted from an auditory component of the inputted multimedia data 101 per frame and stores an average and standard deviation of the audio features with respect to a predetermined number of frames in the feature buffer 105 of FIG. 1 as an audio feature value. In this case, the audio feature may be Mel-Frequency Cepstral Coefficient (MFCC), Spectral Flux, Centroid, Rolloff, Zero Crossing Rate (ZCR), Energy, or Pitch information. The predetermined number is a positive integer greater than 2, for example, 40.

Several conventional methods of generating an audio feature value from auditory components of multimedia data are disclosed in U.S. Pat. No. 5,918,223 whose title is “Method and article of manufacture for content-based analysis, storage, retrieval and segmentation of audio information”, U.S. Patent Publication No. 2003/0040904 whose title is “Extracting classifying data in music from an audio bitstream”, the paper introduced by Zhu Liu, Yao Wang, and Tsuhan Chen [“Audio Feature Extraction and Analysis for Scene Segmentation and Classification” Journal of VLSI Signal Processing Systems Archive Volume 20 pp 61-79, 1998], and the paper introduced by Ying Li and Chitra Dorai [“SVM-based Audio Classification for Instructional Video Analysis” ICASSP2004].

As conventional methods of detecting components of audio information from audio feature values, various statistical learning models such as Gaussian Mixture Model (GMM), Hidden Markov Model (HMM), Neural Network (NN), or Support Vector Machine (SVM) may be used. In the paper introduced by Ying Li and Chitra Dorai [“SVM-based Audio Classification for Instructional Video Analysis” ICASSP2004], a conventional method of detecting audio information using SVM is disclosed.

After the audio feature values and music data are applied to the statistical learning model and the statistical learning model is trained, the genre determination unit 110 of FIG. 1 may determine a ratio of music data included in inputted multimedia data by using the statistical learning model. Next, when the ratio of the music data is more than a predetermined threshold, a genre of the multimedia data is determined to be show/entertainments.

According to another example of the present embodiment, the genre determination unit 110 determines whether audio data included in the multimedia data is handclap/cheer data by analyzing the audio data, and determines the genre of the multimedia data by using a ratio of the handclap/cheer data to the whole multimedia data. In this case, after the audio feature values and the handclap/cheer data are applied to the statistical learning model and the statistical learning model is trained, the genre determination unit 110 of FIG. 1 may determine a ratio of the handclap/cheer data included in the inputted multimedia data by using the statistical learning model. Next, when the ratio of the handclap/cheer data is more than a predetermined threshold, the genre of the multimedia data is determined to be sports. The handclap/cheer data may include either handclap data or cheer data and may include both handclap data and cheer data.

According to another example of the present embodiment, the genre determination unit 110 determines the genre of the multimedia data by using an occupation rate of a predetermined color in frames forming the multimedia data. In the multimedia data of the sports genre, the ratio of the handclap/cheer data is high. Also, in sports such as soccer and baseball, a ratio of green to an image frame is high. Accordingly, a shot is separated from the inputted multimedia data. Next, a ratio of the green to total pixels is computed from color information of the pixels forming key frames of the shot. When the ratio of the green is more than a predetermined threshold, the genre of the multimedia data is determined to be sports.

According to another example of the present embodiment, at least two methods of determining a genre of a multimedia data may be combined. For example, when multimedia data is inputted, the SCR is computed and the genre is determined to be advertisements. If the genre of the inputted multimedia data is not the advertisement genre, whether the multimedia data is included in a news genre is determined by using face information in the multimedia data. If the genre of the inputted multimedia data is not included in the news genre, whether the multimedia data is included in a show/entertainment genre is determined by using a ratio of music data to the multimedia data. If the genre of the inputted multimedia data is not included in the show/entertainment genre, whether the multimedia data is included in a sports genre is determined by using a ratio of handclap/cheer data to the multimedia data. Finally, if the genre of the inputted multimedia data is not the sports genre, the genre of the multimedia data is determined to be a drama/movie genre.

Embodiments of the present invention include program instructions capable of being executed via various computer units and may be recorded in a computer readable recording medium. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., optical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter. The hardware elements above may be configured to act as one or more software modules for implementing the operations of this invention, and its reverse is also true.

A method and apparatus for determining a genre of multimedia data, according to the above-described embodiments of the present invention, may automatically determine the genre of the multimedia data. Specifically, according to the present invention, in what genre the multimedia data is included, such as advertisements, news, show/entertainments, sports, and drama/movie may be determined.

Also, according to the above-described embodiments of the present invention, an optimal summary of multimedia data may be generated by automatically determining a genre of the multimedia data and selecting a summary generation method suitable for the genre.

Also, according to the above-described embodiments of the present invention, multimedia data included in an advertisement genre may be automatically identified by using the SCR.

Also, according to the above-described embodiments of the present invention, the genre of the multimedia data may be automatically determined and, in particular, multimedia data included in a news genre may be precisely identified by using face information included in the multimedia data.

Also, according to the above-described embodiments of the present invention, multimedia data included in a show/entertainment genre may be automatically identified by using a ratio of music data to the multimedia data, and multimedia data included in a sports genre may be automatically identified by using a ratio of handclap/cheer data to the multimedia data.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A data genre determination apparatus comprising:
a feature extractor extracting predetermined feature information from multimedia data; and
a genre determination unit analyzing the extracted feature information of the multimedia data according to multimedia data genre determining logic associated with the extracted feature information and determining a genre of the multimedia data.

2. The apparatus of claim 1, further comprising a summary generator generating a summary of the multimedia data using a summary generation method selected according to the determined genre.

3. The apparatus of claim 1, wherein the genre determination unit determines the genre of the multimedia data using a shot change rate of a segment forming the multimedia data.

4. The apparatus of claim 3, wherein the shot change rate of the segment is a ratio of a number of total shots in the segment to a number of total frames in the segment.

5. The apparatus of claim 4, further comprising:
a scene break detector dividing the multimedia data into a plurality of shots; and
a visual information processor combining the shots into at least one segment according to a predetermined criterion.

6. The apparatus of claim 5, wherein the visual information processor combines the shots into at least one segment using a similarity of a color pattern of each key frame of the shots.

7. The apparatus of claim 1, wherein the genre determination unit determines the genre of the multimedia data by comparing predetermined face information for each genre and information obtained from a face image included in the multimedia data.

8. The apparatus of claim 7, wherein a genre having a greatest correlation is determined to be the genre of the multimedia data by comparing predetermined face information for each genre and information obtained from a face image included in the multimedia data.

9. The apparatus of claim 7, wherein the information obtained from the face image included in the multimedia data is information on an area that is determined to be a face image in a frame selected from frames forming the multimedia data.

10. The apparatus of claim 9, wherein the frame selected from the frames forming the multimedia data is a key frame selected from the frames forming the shot, after dividing the multimedia data into the plurality of the shots.

11. The apparatus of claim 7, wherein predetermined face information for each genre is face map information into which information on pixels, which is determined to be a face area in frames of sample multimedia data selected for each genre, is normalized.

12. The apparatus of claim 11, wherein the pixels determined to be the face area do not include a face image, when the face image, which is detected from the frames of the sample multimedia selected for each genre, is not a major face image.

13. The apparatus of claim 12, wherein the detected face image is determined to be the major face image based on at least one of:
a first criteria when the detected face image is maintained for more than a predetermined time;
a second criteria, different from the first criteria, when the detected face image occupies a larger part of the selected frame than a predetermined size; and
a third criteria, different from the first and the second criteria, when the detected face image is located in a predetermined interesting area.

14. The apparatus of claim 7, further comprising:
a visual information processor extracting information on the face image in the frame selected from the frames forming the multimedia data; and
per-genre face information storage, storing the predetermined face information for each genre, which is information with respect to the face image for each genre.

15. The apparatus of claim 1, wherein the genre determination unit determines whether audio data included in the multimedia data is music data by analyzing the audio data and determines the genre of the multimedia data using a ratio of the music data to all of the multimedia data.

16. The apparatus of claim 1, wherein the genre determination unit determines whether audio data included in the multimedia data is handclap/cheer data by analyzing the audio data and determines the genre of the multimedia data using a ratio of the handclap/cheer data to all of the multimedia data.

17. The apparatus of claim 1, wherein the genre determination unit determines the genre of the multimedia data using an occupation rate of a predetermined color in the frames forming the multimedia data.

18. A method of determining a genre of multimedia data, comprising:
extracting predetermined feature information from the multimedia data; and
analyzing the extracted feature information of the multimedia data according to multimedia data genre determination logic associated with the extracted feature information and determining a genre of the multimedia data.

19. The method of claim 18, wherein, in the determining a genre of the multimedia data, the genre of the multimedia data is determined using a shot change rate of a segment forming the multimedia data.

20. The method of claim 19, wherein the shot change rate of the segment is a ratio of a number of total shots in the segment to a number of total frames in the segment.

21. The method of claim 18, wherein, in the determining a genre of the multimedia data, the genre of the multimedia data is determined by comparing predetermined face information for each genre and information obtained from a face image included in the multimedia data.

22. The method of claim 21, wherein the predetermined face information for each genre is face map information into which information on pixels, which is determined to be a face area in frames of sample multimedia data selected for each genre, is normalized.

23. The method of claim 18, wherein, in the determining a genre of the multimedia data, whether audio data included in the multimedia data is music data is determined by analyzing the audio data, and the genre of the multimedia data is determined using a ratio of the music data to the whole multimedia data.

24. The method of claim 18, wherein, in the determining a genre of the multimedia data, whether audio data included in the multimedia data is handclap/cheer data is determined by analyzing the audio data, and the genre of the multimedia data is determined using a ratio of the handclap/cheer data to the whole multimedia data.

25. The method of claim 18, wherein, in the determining a genre of the multimedia data, the genre of the multimedia data is determined by using an occupation rate of a predetermined color in the frames forming the multimedia data.

26. A computer readable recording medium in which a program for a method of determining a genre of multimedia data is recorded, the method comprising:
extracting predetermined feature information from the multimedia data; and
analyzing the extracted feature information of the multimedia data according to multimedia data genre determination logic associated with the extracted feature information and determining a genre of the multimedia data.

27. The medium of claim 26, wherein, in the determining a genre of the multimedia data, the genre of the multimedia data is determined by using a shot change rate of a segment forming the multimedia data.

28. A multimedia data summary generation method comprising:
extracting predetermined feature information from multimedia data, and
determining a genre of the multimedia data by analyzing the extracted feature information of the multimedia data according to a multimedia data genre determination logic associated with the feature information.

29. A computer readable recording medium in which a program for a multimedia data summary generation method is recorded, the method comprising:
extracting predetermined feature information from multimedia data, and
determining a genre of the multimedia data by analyzing the extracted feature information of the multimedia data according to a multimedia data genre determination logic associated with the feature information.

30. A multimedia data summary apparatus, comprising:
a feature extraction unit extracting predetermined feature information from multimedia data;
a genre determination unit determining a genre of the multimedia data by analyzing the extracted feature information according to a multimedia data genre determination logic associated with the extracted feature information; and
a summary generator generating a summary of the multimedia data by using a summary generation method selected according to the determined genre.
